(19) United States
(12) Patent Application Publication
(10) Pub. No.: US 2026/0048356 A1
(43) Pub. Date: Feb. 19, 2026

(54) TWO-STAGE AIR CLEANER SYSTEM WITH SIDE-POSITIONED PRE-CLEANER AND PRE-CLEANER

(71) Applicant: Donaldson Company, Inc., Bloomington, MN (US)

(72) Inventor: Shirong WANG, Wuxi (CN)

(21) Appl. No.: 19/103,346

(22) PCT Filed: Aug. 11, 2023
(86) PCT No.: PCT/US2023/072099

§ 371 Date: Feb. 12, 2025

(30) Foreign Application Priority Data
Aug. 12, 2022 (CN) 202210967160.8

(51) Int. Cl. B01D 50/20; B01D 45/16; B01D 46/42; B01D 46/48; B01D 46/52; B01D 46/62; B01D 46/76; B04C 5/28; B04C 9/00

(52) U.S. Cl. CPC B01D 50/20; B01D 45/16; B01D 46/4272; B01D 46/48; B01D 46/526; B01D 46/527; B01D 46/62; B01D 46/76; B04C 5/28; B04C 9/00; B01D 2271/02; B04C 2009/002

(57) ABSTRACT

A two-stage air cleaner simple in structure, low in costs, compact and reliable, with automatic dust discharge function. The two-stage air cleaner system can include a main air cleaner and a pre-cleaner positioned at a side of a primary filter cartridge of the main air cleaner. The primary filter cartridge has a dirty side facing downwards and an opposite clean side. The pre-filtered air enters the primary filter cartridge from the dirty side for filtration, and the filtered clean air exits the clean side through an air outlet downstream of the primary filter cartridge. In use, dusts and impurities adsorbed in open channels inside the primary filter cartridge fall into a dust removal arrangement beneath the primary filter cartridge under mechanical vibration and gravity, to automatically discharge from the primary air cleaner, so as to prolong the service life of the primary filter cartridge.

### RELATED APPLICATION

This application is being filed on Aug. 11, 2023, as a PCT International Application, and claims the benefit of and priority to Chinese Patent Application Serial Number 202210967160.8 filed Aug. 12, 2022, the entirety of which is incorporated by reference herein.

### TECHNICAL FIELD

The present disclosure relates to air filtration. In particular, the present disclosure relates to a two-stage air cleaner system with side-positioned pre-cleaner and a pre-cleaner used for such a two-stage air cleaner system. The air cleaner system includes a primary air cleaner which can automatically discharge dusts. The pre-cleaner can greatly improve the pre-filtration efficiency of the pre-cleaner system and reduce dust reingestion effects.

### BACKGROUND

Air flow usually carries a variety of impurities such as dusts, sand, gravel, straws, leaves, soot and moisture. A two-stage air cleaner having a pre-cleaner is typically used to filter intake air of internal combustion engines of various mechanical equipment (including excavators, mining machinery, off-road construction equipment, agricultural equipment, etc.) operating under moderate to severe conditions and/or engine air intake of vehicles. In order to remove various impurities from the air flow, a number of two-stage air cleaner systems have been developed, to constantly seek improvements and breakthroughs with respect to the costs and performance of the products.

Two-stage air cleaner with direct-flow primary filter cartridge or deep pleated panel-type primary filter cartridge are two common types of two-stage air cleaner systems available in the market, both of which comprise a pre-cleaner stage and a primary air cleaner stage, wherein the pre-cleaner is arranged right in front of the dirty side of the primary filter cartridge of the primary air cleaner. The dirty air first enters the pre-cleaner, where larger particles are removed from the air stream with the cyclone action of separator tubes, so that the particles sent to the primary air cleaner can be greatly reduced, which helps to extend the service life of the primary filter cartridge in the primary air cleaner. The air flow to the primary filter cartridge in the primary air cleaner for filtration enters from one end of the primary filter cartridge (i.e., the dirty side), upon filtration, and exits from the opposite end, in which the air flow in the primary filter cartridge generally does not change its flow direction.

However, normally a two-stage air cleaner with a straight-flow primary filter cartridge or a deep pleated panel-type primary filter cartridge is arranged horizontally, with the dirty side of the primary filter cartridge facing towards a side to the pre-cleaner outlet. Thus, the dusts and impurities separated by the primary filter cartridge cannot be discharged from the primary air cleaner and instead can only be accumulated on the primary filter cartridge, so that the primary filter cartridge requires frequent maintenance and/or service. This greatly affects the service life of the primary filter cartridge and increases the costs for the entire two-stage air cleaner. In addition, as the pre-cleaner directly faces the dirty side of the straight-flow primary filter cartridge or deep pleated panel-type primary filter cartridge of the primary air cleaner, the number of separator tubes in the pre-cleaner is limited by the cross-sectional area of the primary filter cartridge, resulting in large initial resistance of the pre-cleaner and two-stage air cleaner.

Certain configurations have been known to have the dirty side of a primary filter cartridge of a two-stage air cleaner with a straight flow primary filter cartridge or a deep pleated panel-type primary filter cartridge facing downwards. However, as the pre-cleaner is arranged underneath the primary filter cartridge, dusts and impurities dropped from the primary filter cartridge during operation cannot be smoothly discharged from the air cleaner housing. As a result, automatic dust removal effect/self-dust removal effect of the primary filter cartridge is not as expected.

For instance, CN Patent No. CN208330577U discloses a two-stage air cleaner with a straight-flow primary filter cartridge. The two-stage air cleaner is composed of a cyclone tube coarse filter assembly as the pre-cleaner and a fine filter assembly as the primary air cleaner. Dirty air enters the housing from the air inlet. Some large particles in the air are thrown into the dust chamber at the bottom by swirling action of the cyclone tubes to complete coarse filtration. Remaining particles are turned to pass through the central duct for fine filtration by the primary filter cartridge. Then, clean air is delivered to the engine via the air outlet.

Here, although the dirty side of the primary filter cartridge of the two-stage air cleaner faces downwards, dust and impurities dropped from the primary filter cartridge during operation cannot be smoothly discharged from the air cleaner housing due to the cyclone tube coarse filter assembly is arranged underneath the primary filter cartridge.

In addition, as the pre-cleaner is positioned underneath the primary air cleaner, dirty air needs to make a turn back to flow out of the air outlet after entering the cyclone tube (see '577U at FIG. 1), which makes the overall length of the entire air cleaner rather long. This leads to even higher requirements to the installation space for the two-stage air cleaner, and in some cases the two-stage air cleaner cannot be accommodated in small cabins.

In order to prolong service life of the filter cartridge and to reduce service time for the air cleaner, a number of products that provide self-dust removal function for the primary filter cartridge have been developed. For example, U.S. Pat. No. 8,404,021B2, CN patent application CN111156116A, etc. all provide a kind of solution. The solution uses active pulsed high-pressure backflushing airflow to blow off the dusts accumulated on the primary filter cartridge. While effective, such solutions require various accessories, including air storage tanks, electric pumping devices, pressure sensors, conduits, wires, valves and other components, which adds cost and therefore may not be suitable for some applications. Further, as high-pressure gas is required to form an air pressure shock wave to blow off the dusts accumulated on the primary filter cartridge, the filter paper of the primary filter cartridge is very likely blown through by the high-pressure backflushing airflow, causing leakage of the primary filter cartridge. Furthermore, the high-pressure backflushing will generate noise at high decibel level; and, dusts blown out by the high-pressure flow will also pollute surrounding environment.

In addition, a considerable number of two-stage air cleaners adopt pre-cleaners with a plurality of cyclone tubes which may be referred to as a bank or set of cyclone tubes. Especially in non-road machinery equipment operating under various moderate/severe dust concentration conditions, the pre-cleaner with cyclone tubes is widely used due to its relatively low initial resistance and stable high pre-filtration efficiency. Such a pre-cleaner mainly includes: a pre-cleaner case having an air intake passage; an upper plate and an opposite baffle plate installed in the pre-cleaner case; a plurality of separate straight tubes each having one end secured to a corresponding hole in the upper plate; a plurality of separate coned tubes each having a conical end secured to a corresponding hole in the baffle plate; a plurality of separate vanes each positioned at the other end of the respective coned tube; and, dust chamber and dust valve. Inlet of the straight tube extends into the coned tube through the vane. One straight tube, one vane and one coned tube constitute a cyclone tube assembly, placed between the upper plate and the baffle plate.

FIGS. 13A-13B illustrate an example cyclone tube assembly 1000 mounted between upper plate 1010 and baffle plate 1020. The cyclone tube assembly 1000 is composed of a straight tube 1030, a vane 1040 and a coned tube 1050. The coned tube 1050 includes a straight tube section and a tapered end section. The outlet 1032 of the straight tube 1030 extends through a corresponding opening in the upper plate 1010, where an interference fit seal 1035 with the upper plate 1010 is achieved. The tapered end 1052 of the coned tube 1050 extends into a corresponding opening in the baffle plate 1020, wherein an interference fit seal 1055 with the baffle plate 1020 is achieved. When the straight tube 1030, the vane 1040 and the coned tube 1050 are assembled in place, as shown in FIG. 13A, the inlet 1034 of the straight tube 1030 extends into the coned tube 1050, and interference fit sealing is achieved between the straight tube 1030, the vane 1040 and the coned tube 1050.

FIGS. 13A-13B show only one cyclone tube assembly 1000. For a cyclone-type pre-cleaner, there will be at least dozens of such cyclone tube assemblies 1000, up to hundreds or thousands, each mounted to corresponding holes in the upper plate 1010 and the baffle plate 1020 and accommodated in the pre-cleaner case.

During operation, dirty air carrying dusts and impurities enters the pre-cleaner through the air intake passage of the pre-cleaner case. Upon forced by the vanes of the cyclone tube assembly, most large particles of dusts and impurities are rapidly rotated along the inner wall of the coned tube, thrown into the dust chamber and accumulated at the bottom dust outlet under the force of gravity, and finally discharged from the pre-cleaner case by the dust valve. The air in the central area of the coned tube close to the inlet of the straight tube carries small amounts of small particles of dusts and impurities, to make a 180-degree turn, to be sucked into the straight tube, and exit the pre-cleaner through the straight tube outlet, to flow towards a downstream primary filter cartridge.

However, existing cyclone pre-cleaners contain a large number of components (depending on the number of individual straight tubes, vanes and coned tubes), causing assembly to be cumbersome and difficult, where professionals and specialized equipment complete such assembly. Maintenance is also a concern for end users during use.

In addition, as each component has its own dimensional deviation together with assembly tolerance, the actual assembled straight tube, vane and coned tube may be laterally misaligned and/or may be misaligned with the upper plate/baffle plate. As a result, the interference fit seal may not work, and air leakage may occur, which greatly reduces filtration efficiency of the pre-cleaner.

As shown in FIG. 13A, the straight tube 1030, the vane 1040 and the coned tube 1050 have their own dimensional deviations; and, when they are assembled together and mounted to the upper plate 1010 and the baffle plate 1020, assembly tolerances may exist. As a result, the following issues can occur: 1) the interference fit seal 1035 between the upper plate 1010 and the straight tube 1030 fails, causing un-prefiltered air to leak into the pre-cleaner from the seal 1035 to enter into a downstream primary filter cartridge; 2) the interference fit seal design between the straight tube 1030, the vane 1040 and the coned tube 1050 fails, causing un-prefiltered air to bypass the vane 1040 to flow into the coned tube 1050, disturbing the airflow; 3) the straight tube 1030 is slanted relative to the coned tube 1050, causing one side of the straight tube inlet 1034 to get closer to the inner wall of the coned tube 1050 than the other side. The large particles of dusts and impurities forced to swirl along the inner wall of the coned tube 1050 by the vane 1040 at the side closer to the inner wall of the coned tube are rather easy to be sucked into the straight tube 1030 as shown by arrow 1060 and flow to a downstream primary filter cartridge; 4) the interference fit seal 1055 between the coned tube 1050 and the baffle plate 1020 fails, causing un-prefiltered air to leak into the dust chamber from the seal 1055, disturbing pre-filtered air flow, and worsening dust reingestion effect. Further, during assembly, there may be height error between the upper plate and the baffle plate and misaligned holes of the upper plate and the baffle plate, causing lateral dislocation of the cyclone tube assembly. All these issues severely affect pre-filtration efficiency of a cyclone-type pre-cleaner.

It is noted that dust reingestion effect unavoidably exists in the dust chamber of a cyclone-type pre-cleaner. Dust reingestion effect refers to, a small amount of dusts/impurities filtered by the cyclone tube assembly and thrown into the dust chamber, along with the airflow in the dust chamber, will be sucked back into the straight tube from the tapered port of the coned tube, to flow to downstream primary filter cartridge, thereby reducing pre-filtration efficiency. This is because when large particles of dusts and impurities are thrown into the dust chamber, some air will also be carried together to be thrown into the dust chamber, so that the air and dusts inside the dust chamber have been disturbed. In order to maintain certain air volume and negative pressure, excess air in the dust chamber will be sucked back into the coned tube, so that this part of air carrying the dusts from the dust chamber will flow into the straight tube through the coned tube, and then will flow out of the pre-cleaner and enter the downstream primary filter cartridge.

Particularly, in many cases, due to factors such as arrangement of the cartridge of the air cleaner, arrangement of air intake, intake air near some installation places being blocked by the mounting bracket of machine, the inlet surface being too close to the intake air, and some cyclone tube assemblies being blocked by dusts and impurities after working for a period of time, air intake of the pre-cleaner is imbalanced. The coned tubes of the cyclone tube assemblies that experience larger air intake resistance and smaller air intake flow will have larger pressure difference relative to the dust chamber and need to receive more excess air from the dust chamber; while the cyclone tube assemblies with large intake flow will more quickly discharge air and dusts, which will flow from the dust chamber to the coned tubes of the cyclone tube assemblies that have smaller intake air flow. Such asymmetrical air flow pattern will cause increased lateral turbulence in the dust chamber, and more dusts and impurities will flow to the cyclone tube assemblies that have larger intake resistance and smaller intake flow with the turbulence, to be sucked back into the coned tubes and then flow towards the downstream primary filter cartridge via the straight tubes, thereby greatly reducing pre-filtration efficiency of the pre-cleaner. Moreover, dust reingestion effect will eventually cause the tapered ports of the coned tubes of the cyclone tube assemblies that have the minimal air intake flow to be blocked, further worsening pre-filtration efficiency.

In view of the many issues as discussed above with the existing cyclone-type pre-cleaner that pre-filtration efficiency reaches a limit, there is a trend to replace cyclone-type pre-cleaners with various straight-through pre-cleaners which are more simple in structure, more compact for space, more cost effective, and have lower initial resistance. Further, as cyclone-type pre-cleaners are still desirable in off-road machinery and equipment, especially in machinery and equipment operating under moderately/severe working conditions, there is a need for a cyclone-type pre-cleaner which has higher pre-filtration efficiency and is convenient for maintenance. Also, a two-stage air cleaner system using such cyclone-type pre-cleaner has been sought.

In addition, there is a need for a two-stage air cleaner system which is more simple in structure, more reliable, low in costs, more compact, and preferably is capable of automatic dust discharge.

### SUMMARY

In view of above, one object of the present disclosure is to provide a two-stage air cleaner system that is simple in structure, safe and reliable, low in cost, compact in size and preferably can achieve automatic dust discharge function.

Another object of the present disclosure is to provide a cyclone-type pre-cleaner that has higher pre-filtration efficiency and is convenient for maintenance and to provide a two-stage air cleaner system using such a cyclone-type pre-cleaner, so as to prolong service interval of the two-stage air cleaner system, reduce maintenance frequency of the pre-cleaner and the primary filter cartridge, and reduce the costs.

In order to solve the above technical problems, the present disclosure adopts the following technical solutions.

In one aspect, the present disclosure provides a two-stage air cleaner system with a side-positioned pre-cleaner, comprising: a main air cleaner and a pre-cleaner arranged at a side of a primary filter cartridge of the main air cleaner, the pre-cleaner having an inlet and an outlet, the outlet facing in a first direction; wherein the primary filter cartridge includes a dirty side, facing in a second direction orthogonal to the first direction, and an opposite clean side; wherein air to be filtered, upon being pre-filtered by the pre-cleaner, enters the primary filter cartridge from the dirty side for filtration, and filtered clean air exits from the clean side through an air outlet downstream of the primary filter cartridge; wherein, when the two-stage air cleaner system is in use, some of the dust and impurities collected in upstream channels inside the primary filter cartridge can fall into a dust removal arrangement arranged beneath the primary filter cartridge under gravity, to automatically discharge from the main air cleaner.

In one aspect, the present disclosure provides a two-stage air cleaner system with a side-positioned pre-cleaner, comprising: a main air cleaner and a pre-cleaner arranged at a side of a primary filter cartridge of the main air cleaner; wherein, the primary filter cartridge includes a dirty side with an opening facing downward and a clean side opposite to the dirty side; wherein air to be filtered, upon pre-filtered by the pre-cleaner, enters into the primary filter cartridge from the dirty side for filtration, and filtered clean air exits from the clean side through an air outlet downstream of the primary filter cartridge; when the two-stage air cleaner system in operation, dusts and impurities adsorbed or otherwise collected in open channels inside the primary filter cartridge fall into a dust discharge arrangement beneath the primary filter cartridge under gravity, to automatically discharge from the main air cleaner.

Preferably, a safety filter cartridge is arranged downstream of the primary filter cartridge. The clean air filtered by the primary filter cartridge enters into the safety filter cartridge from the clean side for secondary filtration, and then the air filtered by the safety filter cartridge exits through an air outlet downstream of the safety filter cartridge.

Preferably, the primary filter cartridge is a straight-flow filter cartridge.

Preferably, the primary filter cartridge includes a media pack composed of media of a fluted sheet attached to a face sheet, having a first edge and an opposite second edge, wherein the first edge forms the dirty side of the primary filter cartridge, and the second edge forms the clean side of the primary filter cartridge; a sealing edge provided near the second edge to seal the fluted sheet and the face sheet together and preventing the air to be filtered entering into the dirty side from flowing out of the clean side without being filtered by the media; the air to be filtered entering open flutes at the dirty side, passing through the media into adjacent channels, and exiting from the clean side.

Preferably, the open flutes at the dirty side form open channels inside the primary filter cartridge, to collect dust and impurities.

Preferably, the dust discharge arrangement is in a shape of a funnel for accumulating dusts and impurities, and the dust discharge arrangement includes a dust discharge valve.

Preferably, the two-stage air cleaner system, when in operation, vibrates to cause dusts and impurities to fall into the dust discharge valve and accumulate in the dust discharge valve under gravity, until an amount of accumulated dusts and impurities makes its self-gravitation sufficient to overcome negative pressure inside the main air cleaner, to allow automatic discharge from the main air cleaner housing through the dust discharge valve.

Preferably, the media of the primary filter cartridge can be wound around itself or around a core to form a coiled media pack.

Preferably, the media of the primary filter cartridge can be a media composed of a fluted sheet and a face sheet stacking one another to form a stacked media pack.

Preferably, the primary filter cartridge is a deep pleated panel-type filter cartridge.

Preferably, the pre-cleaner comprises an air inlet, a cyclone tube installed inside the pre-cleaner, a dust chamber downstream of the cyclone tube, and a dust outlet disposed below the dust chamber; wherein the dirty air enters the pre-cleaner from the air inlet, under the swirling action of the cyclone tube, large particles of dusts and impurities are thrown into the dust chamber and discharged from the pre-cleaner via the dust outlet, and the pre-filtered air then flows to the dirty side of the primary filter cartridge.

In another aspect, the present disclosure provides a two-stage air cleaner system with a side-positioned pre-cleaner, comprising: a main air cleaner and a pre-cleaner arranged at a side of a primary filter cartridge of the main air cleaner; wherein the primary filter cartridge includes a dirty side and a clean side; wherein air to be filtered, upon pre-filtered by the pre-cleaner, enters into the primary filter cartridge from the dirty side for filtration by the primary filter cartridge and a safety cartridge, and the filtered clean air is discharged from the clean side through an air outlet downstream of the safety cartridge.

In another aspect, the present disclosure provides a pre-cleaner, comprising: pre-cleaner housing providing air intake passage; an upper baffle member, cyclone tube member set and a lower baffle member contained in the pre-cleaner housing; and a dust cover attached to the pre-cleaner housing, forming a dust chamber inside the pre-cleaner housing. The upper baffle member has a plurality of openings. The cyclone tube member set includes a cyclone tube member base plate and a plurality of cyclone tube members secured to the cyclone tube member base plate, each cyclone tube member composed of an outer straight tube, a vane inside the outer straight tube, and a central tube inserted into the outer straight tube, which are integrally formed together as a single component. The number and position of the cyclone tube members match with the number and position of the openings of the upper baffle member, and an end of the central tube of each cyclone tube member extends into corresponding opening of the upper baffle member. The lower baffle member has a plurality of tapered tubes, the number of which corresponds to the number of the cyclone tube members, and an end of the outer straight tube of each cyclone tube member aligns with an end of corresponding tapered tube.

Preferably, the upper baffle member includes an upper baffle plate and a seal member attached to the upper baffle plate. The upper baffle plate includes a plurality of openings. The seal member is an integrally formed sealing ring gasket, including a plurality of sealing rings, the position and number of which match with the position and number of the openings of the upper baffle plate. In addition, each sealing ring forms an airtight engagement with each corresponding opening of upper baffle plate.

In some examples, the seal member is formed from a relatively soft material. In some examples, the material is a soft rubber material. In some examples, the material is a thermoplastic elastomer (TPE). Preferably, the seal member is an integrally formed TPE sealing ring gasket, engaged to the upper baffle plate.

Preferably, each sealing ring has a retainer for assisting an end of the central tube of each cyclone tube member that extends into respective opening in position, to have the sealing ring to form a seal with the end of the central tube, so as to prevent un-prefiltered air from flowing out of the pre-cleaner.

Preferably, the cyclone tube member base plate and the plurality of cyclone tube members secured to the cyclone tube member base plate are integrally formed.

Preferably, the lower baffle member includes an integrally formed lower baffle plate and a plurality of tapered tubes secured to the lower baffle plate.

Preferably, the cyclone tube member set is positioned relative to the lower baffle member with guide pins, and sealingly engaged thereto by way of adhesives or fasteners.

Preferably, the dust chamber is provided with an anti-dust reingestion arrangement.

Preferably, the anti-dust reingestion arrangement is a single piece, formed integrally with the dust cover, or formed integrally with the lower baffle member.

Preferably, the anti-dust reingestion arrangement has a plurality of lattices, for dividing the dust chamber and the tapered tubes on the lower baffle plate into a plurality of compartments.

Preferably, the anti-dust reingestion arrangement has a plurality of sheet-shaped partitions, for dividing the dust chamber and the tapered tubes on the lower baffle plate into a plurality of compartments.

Preferably, the dust cover is integrated with an anti-dust reingestion grid.

Preferably, the lower baffle member is a collection set comprising a plurality of lower baffle members.

Preferably, the cyclone tube member set is a collection set comprising a plurality of cyclone tube member sets.

Preferably, the lower baffle member is a collection set comprising a plurality of lower baffle members, and the cyclone tube member set is a collection set comprising a plurality of cyclone tube member sets, wherein individual lower baffle member and individual cyclone tube member set are fastened to each other and arranged on the base frame.

In another aspect, the present disclosure provides a two-stage air cleaner system with a side-positioned pre-cleaner, the two-stage air cleaner system using the above-mentioned pre-cleaner.

In another aspect, the present disclosure provides a two-stage air cleaner system including the pre-cleaner as described above and a main air cleaner downstream of the pre-cleaner.

Comparing with existing two-stage air cleaner, the present disclosure has advantages by having the pre-cleaner arranged at a side of a primary filter cartridge of the main air cleaner, including:
1. More cyclone tubes can be arranged (comparing with conventional ones, the number of cyclone tubes can be roughly doubled), which can substantially reduce initial resistance of the pre-cleaner and the entire two-stage air cleaner system;
2. For a two-stage air cleaner system having cyclone-type pre-cleaner, the structure is more compact. As the overall length of the system is shortened, the system is more convenient to be arranged on a machine;
3. Effective automatic dust discharge can be achieved with more simple structure, more safe and reliable way, lower costs and more compact space, which greatly increases service life of the primary filter cartridge, prolongs maintenance period of the primary filter cartridge, and reduces costs of use of the air cleaner system.

In addition, the cyclone-type pre-cleaner of the present disclosure adopts the newly designed cyclone tube member and anti-dust reingestion arrangement, which bring advantages over the existing cyclone-type pre-cleaner, including:
1. With the new design, the structure of the cyclone-type pre-cleaner is simplified. The new design does not need the interference fit seal between the straight tube, the vane and the coned tube and one-to-one insertion installation (i.e., the straight tube inserts into the coned tube and passes through the vane placed in the coned tube) that are required in the existing pre-cleaner, which not only greatly reduces the total number of components but also substantially decreases difficulty for assembly.
2. Transverse misalignment between the straight tube, the vane and the coned tube caused by height error between the upper and lower baffle plates and misalignment of the openings of the upper and lower baffle plates in the existing pre-cleaner will not occur. Also, issues such as air leakage caused by failure of interference fit seal between components can be avoided. Thus, pre-filtration efficiency is greatly improved.
3. By introducing the anti-dust reingestion arrangement, dust reingestion effect under imbalanced air intake can be greatly reduced, thereby improving stability and adaptability of the pre-cleaner with super-high pre-filtration efficiency.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof. The scope herein is defined by the appended claims and their legal equivalents.

### BRIEF DESCRIPTION OF THE DRAWINGS

FIG. 1 shows a simplified schematic diagram of a two-stage air cleaner system with a side-positioned pre-cleaner according to one embodiment of the present disclosure.

FIG. 2 shows a perspective view of a two-stage air cleaner system with a side-positioned pre-cleaner according to one embodiment of the present disclosure.

FIG. 3 is an exploded view of the two-stage air cleaner system as shown in FIG. 2.

FIG. 4 is a front view of the two-stage air cleaner system as shown in FIGS. 2-3.

FIG. 5 is a cross-sectional view at a main air cleaner side of the two-stage air cleaner system as shown in FIGS. 2-4.

FIG. 6 is a cross-sectional view of the two-stage air cleaner system of FIGS. 2-5, showing cyclone tubes arranged in the pre-cleaner.

FIG. 7 shows a partial schematic perspective view of filter medium that constitutes the primary filter cartridge of the main air cleaner according to one embodiment of the present disclosure.

FIG. 8 is a schematic view of air flow in the channel of the media pack composed of the filter medium as shown in FIG. 7.

FIG. 9 shows a schematic perspective view of a filter media pack that constitutes a panel-type primary filter cartridge of a main air cleaner according to another embodiment of the present disclosure.

FIG. 10 shows a schematic view of air flow in the channel of the panel-type primary filter cartridge as shown in FIG. 9.

FIG. 10A is a partial enlarged view of FIG. 10.

FIG. 11 is an exploded perspective view of a two-stage air cleaner system with a side-positioned pre-cleaner according to another embodiment of the present disclosure.

FIG. 12 is an exploded perspective view of a two-stage air cleaner system with a side-positioned pre-cleaner according to another embodiment of the present disclosure.

FIG. 13A shows an exemplary cyclone tube assembly of prior art, in which the cyclone tube assembly has been assembled and mounted onto the upper and lower baffle plates.

FIG. 13B shows an exploded view of the cyclone tube assembly of FIG. 13A prior to assembly.

FIG. 14 shows an exploded schematic view of a cyclone-type pre-cleaner according to one embodiment of the present disclosure.

FIG. 15 shows a partial cut-away view of the assembled components of the cyclone-type pre-cleaner as shown in FIG. 14.

FIGS. 16A-16B are schematic views of an integrally formed upper baffle member according to one embodiment of the present disclosure, wherein FIG. 16A is an exploded view and FIG. 16B is an assembled view.

FIG. 16C is an enlarged schematic view at the joint between the upper baffle member and the cyclone tube member.

FIG. 17 shows a cyclone tube member and a cyclone tube member set integrally formed by a plurality of cyclone tube members according to one embodiment of the present disclosure.

FIG. 18 shows an integrally formed lower baffle member and a single tapered tube according to one embodiment of the present disclosure.

FIG. 19A shows a schematic view of individual cyclone tube member of the cyclone tube member set being aligned with respective tapered tube of the lower baffle member for installation.

FIG. 19B shows a partial cut-away perspective view of assembled upper baffle member, cyclone tube member set and lower baffle member.

FIG. 20A is a schematic view showing a single cyclone tube member aligned with respective tapered tube of the lower baffle plate and engaged thereto.

FIG. 20B is an exploded schematic view of individual components of FIG. 20A before being assembled.

FIG. 21 is a schematic view showing operation of the cyclone tube member of the present disclosure.

FIG. 22A is a schematic view showing an anti-dust reingestion arrangement disposed in a dust chamber according to one embodiment of the present disclosure, in which the anti-dust reingestion arrangement is used in a pre-cleaner with cyclone tubes vertically arranged.

FIG. 22B is a perspective view of the anti-dust reingestion arrangement as shown in FIG. 22A.

FIG. 23A is a schematic view showing an anti-dust reingestion arrangement disposed in a dust chamber according to another embodiment of the present disclosure, in which the anti-dust reingestion arrangement is used in a pre-cleaner with cyclone tubes horizontally arranged.

FIG. 23B is a perspective view of the anti-dust reingestion arrangement as shown in FIG. 23A.

FIG. 24 is a perspective view of a dust cover integrated with an anti-dust reingestion grid work according to another embodiment of the present disclosure.

FIG. 25 shows an alternative embodiment of a lower baffle member.

FIG. 26 shows an alternative embodiment of a cyclone tube member set.

FIGS. 27A-27B illustrate another alternative embodiment of the cyclone tube member set and lower baffle member.

### DETAILED DESCRIPTION

In order to elaborate the objectives, technical solutions and advantages of the present disclosure, detailed description is provided in connection with the accompanying drawings and embodiments. It should be understood that the specific embodiments described herein are only for illustrative and not restrictive purposes.

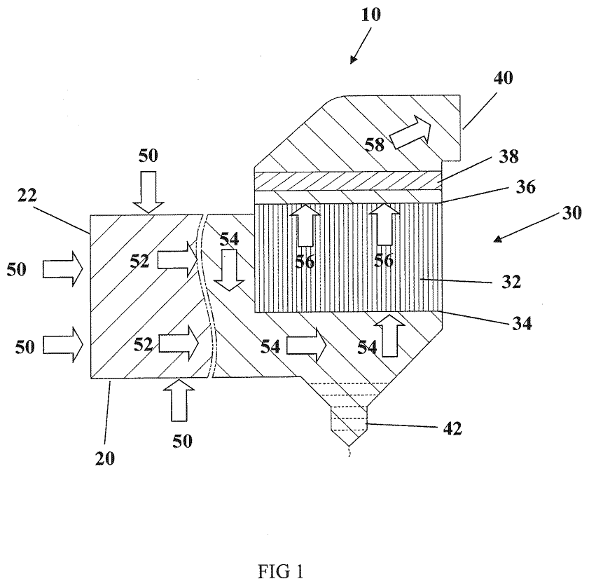

Attention is now directed to FIG. 1, which is a simplified schematic view of a two-stage air cleaner system according to one embodiment of the present disclosure. As shown in FIG. 1, the two-stage air cleaner system 10 is mainly composed of a main air cleaner 30 and a pre-cleaner 20 arranged on a side of a primary filter cartridge 32 of the main air cleaner 30. The housings of the main air cleaner and the pre-cleaner can be integrally injection-molded or can be connected by welding or fasteners such as bolts. As shown, dirty air enters the pre-cleaner 20 along arrow 50. Upon pre-filtration by the pre-cleaner 20, water (if present) and larger/heavier dust particles are separated from the air. The separated dust particles accumulate in a dust collection arrangement 22 of the pre-cleaner 20, and then exit the pre-cleaner 20 via a dust outlet under gravity.

The pre-filtered air then flows out of the pre-cleaner 20 in the direction of arrow 52, and makes a turn as shown by arrows 54 into a dirty side 34 of the primary filter cartridge 32 of the main air cleaner 30 for further filtration.

The dirty side 34 of the primary filter cartridge 32 faces downwards to receive the air flow pre-filtered by the pre-cleaner 20 along arrow 54. The primary filter cartridge 32 can be straight-flow primary filter cartridge, deep pleated panel-type primary filter cartridge and the like, to have the air flow to enter from the dirty side 34, filtered by the primary filter cartridge 32, and exit from the opposite clean side 36 in the direction of arrow 56. Then, the air flow will be discharged through the air outlet 40 as shown by arrow 58 to the engine. Optionally, a safety cartridge 38 may be arranged downstream of the primary filter cartridge 32, so that the air filtered by the primary filter cartridge 32 will flow through the safety cartridge 38 for secondary filtration and will then be sent to the engine.

A dust removal arrangement 42 is provided below the dirty side 34 of the primary filter cartridge. In one example, the dust removal arrangement 42 may include a dust discharge valve. The media pack that constitutes the primary filter cartridge 32 and its media configuration will be discussed further below. When the two-stage air cleaner system 10 is in operation, the dusts and impurities sucked into the open channels in the primary filter cartridge 32 can fall down due to vibration of the air cleaner system and under gravity and will accumulate in the dust removal arrangement 42. As more and more dusts and impurities accumulate, its own weight is sufficient to overcome negative pressure inside the main air cleaner, to allow dusts and impurities to automatically discharge from the main air cleaner through the dust removal arrangement 42, so as to greatly prolong service life of the primary filter cartridge.

In the present disclosure, the pre-cleaner 20 may be any form of pre-cleaner having dust collection or dust discharge function, including but not limited to, pre-filter dust-discharge module with cyclone tubes, pre-filter dust-collection module with porous foam material, pre-filter dust-collection module with cartridge (in series connection with the primary filter cartridge in the main housing), and the like. As an example, a cyclone-type pre-cleaner that can be used in the two-stage air cleaner system of the present disclosure will be described in further detail below.

As the upstream pre-cleaner 20 is arranged at a side of the primary filter cartridge 32 of the main air cleaner 30 which has a larger cross-sectional area, this avoids restriction by the cross-sectional area of the primary filter cartridge, and more cyclone tubes can be installed in the pre-cleaner 20, thereby significantly reducing initial resistance of the pre-cleaner and the entire two-stage air cleaner system, allowing larger air flow.

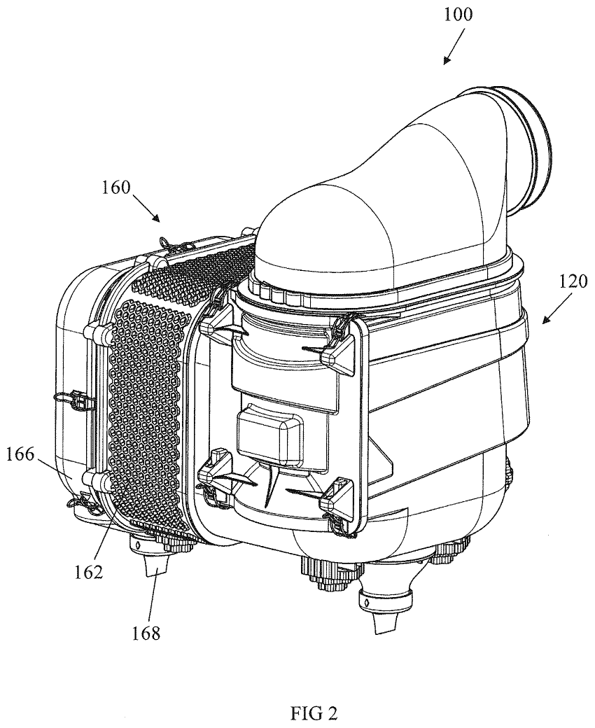

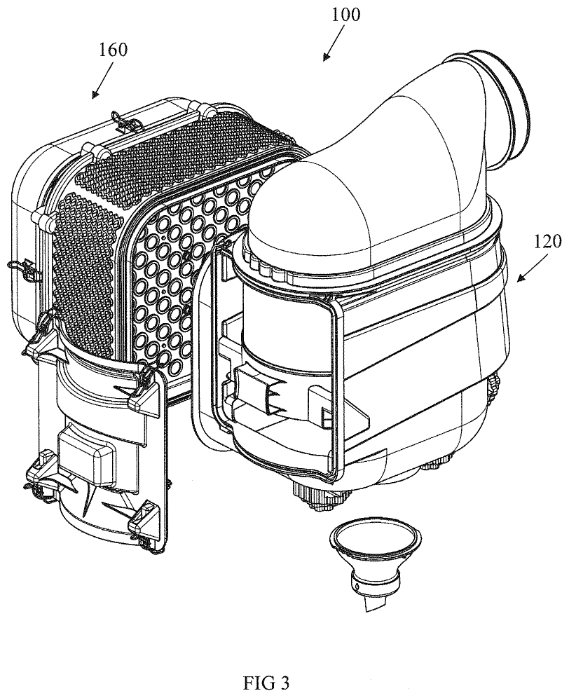

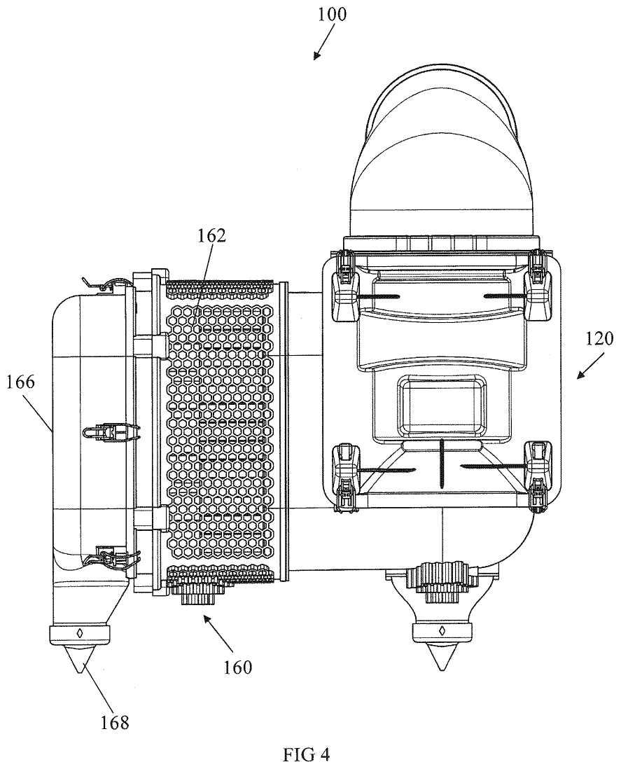

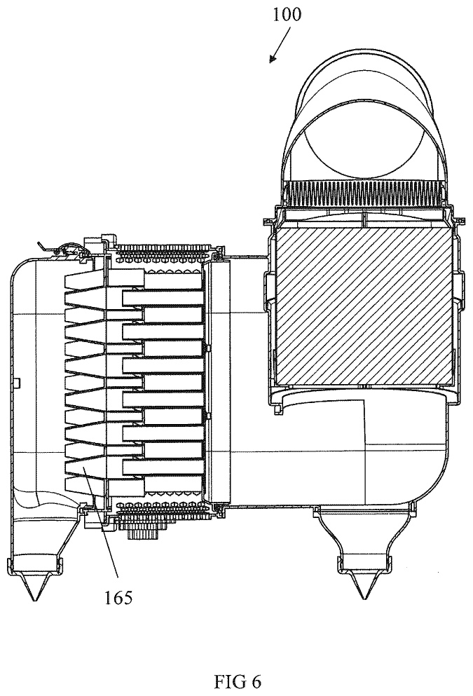

Turning now to FIGS. 2-6, reference numeral 100 shows a two-stage air cleaner system according to one embodiment of the present disclosure. The two-stage air cleaner system 100 includes a main air cleaner 120 and a pre-cleaner 160 arranged at a side of the primary filter cartridge 130 of the main air cleaner 120. The housing of the main air cleaner and the housing of the pre-cleaner can be integrally injection-molded or connected by welding or fasteners such as bolts. In this embodiment, dirty air enters the pre-cleaner 160 through the air inlet 162. In one example, the air inlet 162 may be window-shaped air intake grids on four sides of the pre-cleaner housing, as shown in FIGS. 2-5. Certainly, other forms of air inlets may also apply to the pre-cleaner of the present disclosure. The dirty air entering the pre-cleaner 160 through the air inlet 162 is swirled by the cyclone tubes therein, with large particles thrown into the dust chamber 166 and discharged from the pre-cleaner 160 via the dust outlet 168 below the dust chamber 166. In one embodiment, the dust outlet 168 includes a dust discharge valve. The pre-filtered air is then delivered to the dirty side of the primary filter cartridge of the main air cleaner 120 for further filtration. In particular, for this example, the pre-filtered air is then turned 180 degrees to be delivered to the dirty side of the primary filter cartridge of the main air cleaner 120 through the central tube of the cyclone tube 165 (see FIG. 6).

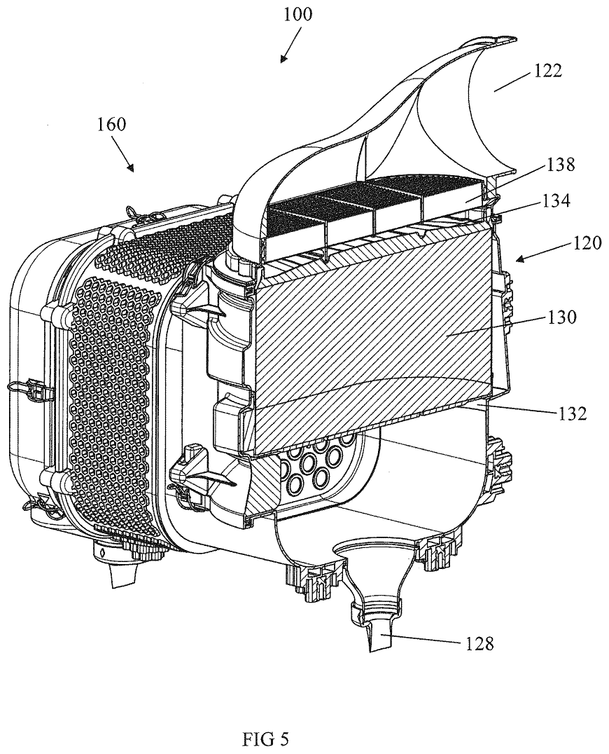

It can be seen from FIG. 5 that the main air cleaner 120 has a primary filter cartridge 130, which can have a coiled media pack or a stacked media pack, with a cross-section to be circular, oval, oblong, rectangular, or any suitable shape. In addition, the primary filter cartridge 130 can also be panel-type cartridge using deep pleat technology. In the illustrated embodiment, the dirty side 132 of the primary filter cartridge 130 faces downwards to receive the pre-filtered air flow from the pre-cleaner 160. The primary filter cartridge 130 can be straight-flow primary filter cartridge or deep pleated panel-type primary filter cartridge. Air flow enters the primary filter cartridge 130 from one end (e.g., the dirty side 132) for filtration, and clean air exits from the opposite end (e.g., the clean side 134) through the air outlet 122 to the engine. Optionally, a safety cartridge 138 is arranged downstream of the primary filter cartridge 130. For this case, the air filtered by the primary filter cartridge 130 will then passes through the safety cartridge 138 for secondary filtration, and then be discharged to the engine through the air outlet 122. A dust removal arrangement 128, in the shape of a funnel, is provided underneath the dirty side 132 of the primary filter cartridge, for accumulating dusts and impurities.

In this embodiment, as the upstream pre-cleaner 160 is arranged at a side of the primary filter cartridge 130 of the main air cleaner 120 which has a larger cross-sectional area, this avoids restriction by the cross-sectional area of the primary filter cartridge, and more cyclone tubes can be installed in the pre-cleaner 160, thereby significantly reducing initial resistance of the pre-cleaner and the entire two-stage air cleaner system, allowing larger air flow. The number of cyclone tubes can be determined based on particular application needs.

Further, comparing with existing air cleaner systems, as the pre-cleaner of FIGS. 2-6 adopts rather long cyclone tubes, by placing the pre-cleaner at a side of the primary filter cartridge, the overall length of the entire two-stage air filter system is shortened, and the overall structure is more compact to facilitate installation in cabins with limited space. With respect to example cyclone-type pre-cleaner, further details will be given below.

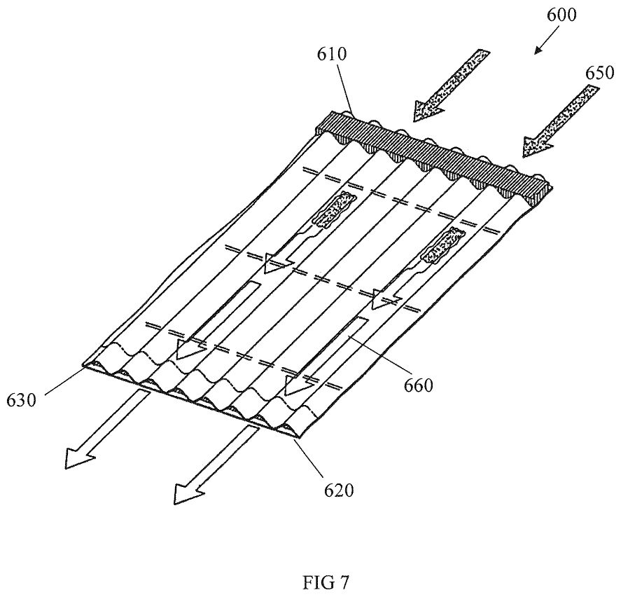

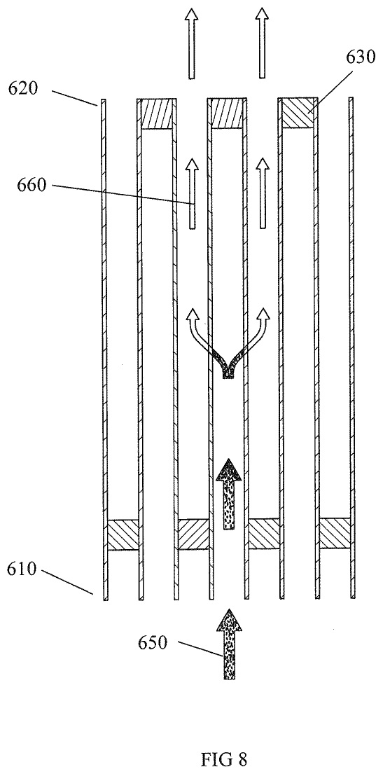

FIGS. 7-8 illustrate an example of filter medium and its channel passage used in the primary filter cartridge of the present disclosure. The primary filter cartridge can have a coiled media pack formed by wrapping the media 600 itself, or the media 600 may be wrapped around a core. Alternatively, the primary filter cartridge can have a stacked media pack formed by stacking the media 600. The media 600 may be a fluted sheet/surface sheet combination having first and second opposite edges 610 and 620. When the media 600 is coiled/stacked to form a media pack, typically the edge 610 will form the inlet side (i.e., dirty side) of the media pack, and the edge 620 will form the outlet side (i.e., clean side). Sealant beads 630 are provided near the edge 620 to seal the fluted sheet and surface sheet together and prevent air to be filtered entering from the dirty side from exiting the clean side without being filtered by the media. In use, air to be filtered (e.g., pre-filtered air from the pre-cleaner) enters the open flutes near edge 610 as shown by arrow 650. Since the edge 620 along the channel formed by the open flute is closed by the sealant beads 630, air is forced to pass through the medium into adjacent open channel. Filtered clean air then exits the media through the flute open end near edge 620 as shown by arrow 660, while dusts and impurities are adsorbed in the channels formed by the open flutes near the edge 610. Here, as long as the media configuration is one with straight-through channels in the media pack that can receive dusts or in which dusts and impurities can be dropped by mechanical vibration and gravity, such media configuration may be used for the present disclosure.

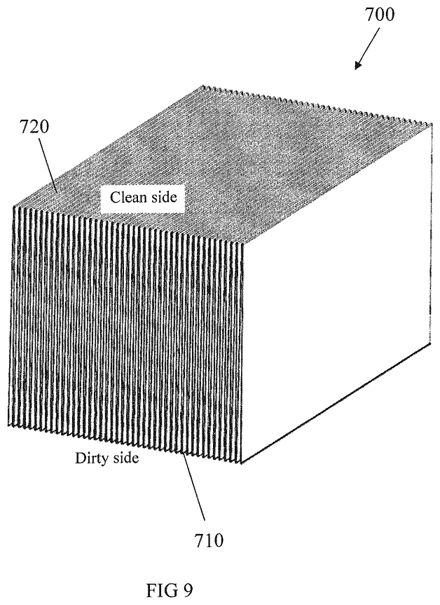

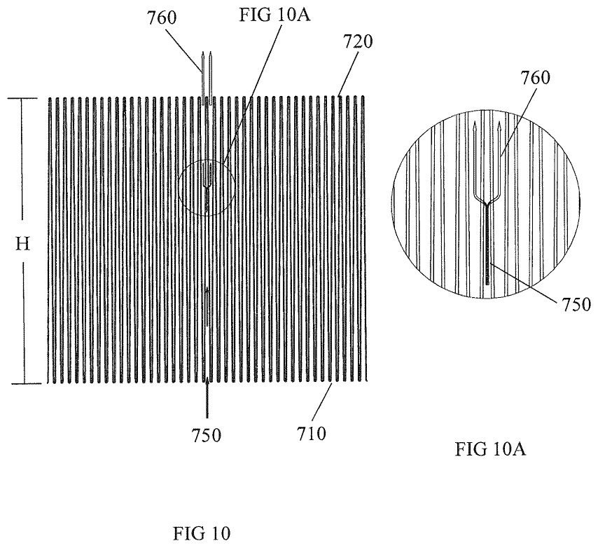

For instance, FIGS. 9 and 10-10A illustrate an example of a panel-type filter cartridge 700 using deep pleat technology. Typically, the performance of a filter cartridge depends in part on the filtration area of its filter paper. Increasing filtration area can reduce the initial resistance of the filter cartridge under certain air flow, and increase the dust holding capacity. Comparing with conventional pleats with a pleat depth of between about 8.9mm-76.2mm, pleats using deep pleat technology can have much greater pleat depth. This allows the pleats which has similar filtration area to that of a straight-flow cartridge under similar geometric dimensions to be made into a panel type, instead of a conventional cylindrical shape. In such, the deep pleated panel-type filter cartridge also has an air intake end, i.e., dirty side; and an air outlet end, i.e., clean side. In the embodiment of FIGS. 9-10, the pleat depth H is the distance from the dirty side 710 to the clean side 720 of the filter cartridge 700. Thus, air to be filtered (e.g., pre-filtered air from a pre-cleaner) enters the open flutes near dirty side 710 as shown by arrow 750 and is forced to pass through the media to adjacent open channels since the other end of the channel along the open flutes (i.e., clean side 720) is folded and closed. Filtered clean air then exits the media through the open flutes near the clean side 720 as shown by arrow 760, while dusts and impurities are collected in the channels formed by the open flutes near the dirty side 710.

In the present disclosure, the dirty side 34/132 of the primary filter cartridge 32/130 faces downwards, which means that individual channels formed by the opening flutes for receiving dusts and impurities also face downwards. In use, under mechanical vibration of the air cleaner system and weight of impurities, especially continuous small vibration and occasional intensive vibration during operation of the air cleaner system, plus intake flow of the engine being inconstant with transient variation, negative pressure in the primary filter cartridge will change with the intake flow. Dusts and impurities sucked into the open channels formed by the open flutes can fall from the dirty side and accumulate in the dust removal arrangement 42/128 under the primary filter cartridge 32/130. In one example, the dust removal arrangement 42/128 may include a dust discharge valve. As more and more dusts and impurities accumulate, its own weight is sufficient to overcome negative pressure inside the main air cleaner, so that dusts and impurities are automatically discharged from the main air cleaner housing through the dust discharge valve.

In addition, since the pre-cleaner of the present disclosure is arranged at a side of the primary filter cartridge to allow the dirty side of the primary filter cartridge to face down directly towards the underneath dust removal arrangement, together with the direct-flow primary filter cartridge/deep pleated panel-type primary filter cartridge using straight-through open channels to collect dusts and impurities, when the air cleaner system in use, dusts and impurities will be affected by vibration and change of negative pressure, to achieve automatic dust removal with gravity. Comparing with current high-pressure air pulse self-cleaning solutions, the present disclosure greatly simplifies the structure, reduces the costs, and at the same time meets the requirements of safe and reliable filtration performance.

It should be understood that the above-mentioned embodiments of the present disclosure are only exemplary, the structure and internal construction of the two-stage air cleaner system may vary depending on particular application.

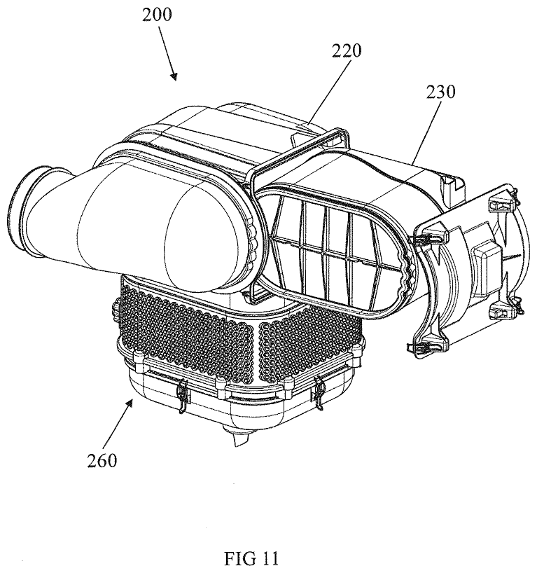

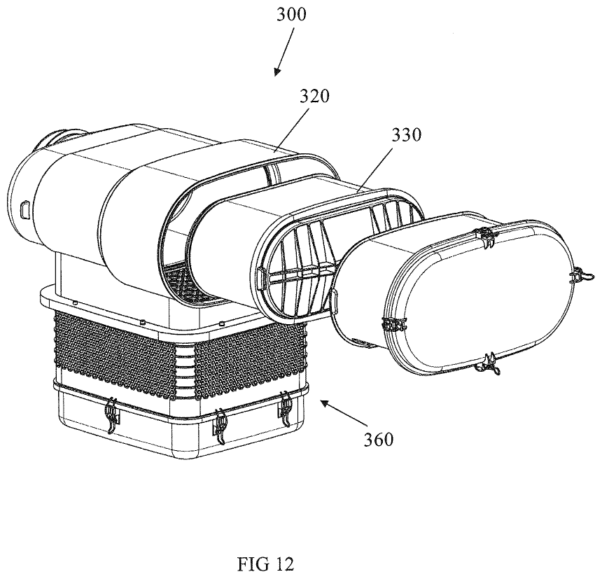

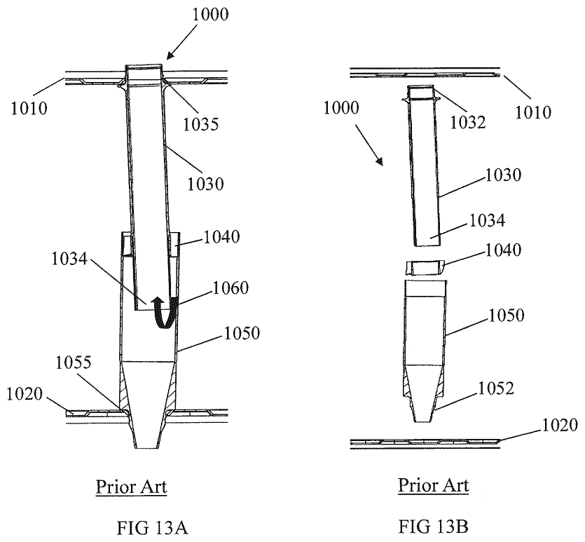

For instance, FIGS. 11-12 show alternative designs of a two-stage air cleaner system with a pre-cleaner positioned at a side of a primary filter cartridge. In the two-stage air cleaner system 200 of FIG. 11, the pre-cleaner 260 is located under the main air cleaner 220, at a side of the primary filter cartridge 230. The cyclone tubes in the pre-cleaner 260 are arranged vertically, and the straight-flow primary filter cartridge 230 of the main air cleaner 220 is placed horizontally. The two-stage air cleaner system 300 of FIG. 12 includes a main air cleaner 320 and a pre-cleaner 360 positioned under the main air cleaner 320. As shown, the pre-cleaner 360 is positioned at a side of the primary filter cartridge 330. The cyclone tubes in the pre-cleaner 360 can be arranged horizontally or vertically, and the straight-flow primary filter cartridge 330 of the main air cleaner 320 can be placed horizontally.

For the designs of FIGS. 11-12, as the upstream pre-cleaner 260/360 is positioned at a side of the primary filter cartridge 230/330 which has a larger cross-sectional area, this avoids restriction by the cross-sectional area of the primary filter cartridge, and more cyclone tubes can be installed in the pre-cleaner 260/360 (comparing with existing air cleaner systems, the number of cyclone tubes in the pre-cleaner of the present disclosure can be up to doubled), thereby significantly reducing initial resistance of the pre-cleaner and the entire two-stage air cleaner system, allowing larger air flow.

Also, comparing with existing air cleaner systems, as the cyclone-type pre-cleaner is positioned at a side of the primary filter cartridge, the overall length of the entire two-stage air cleaner system is shortened, and the overall structure is more compact, which facilitates installation in cabins with limited space.

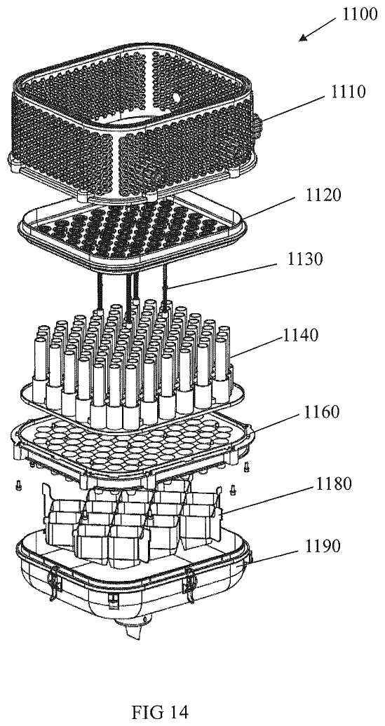

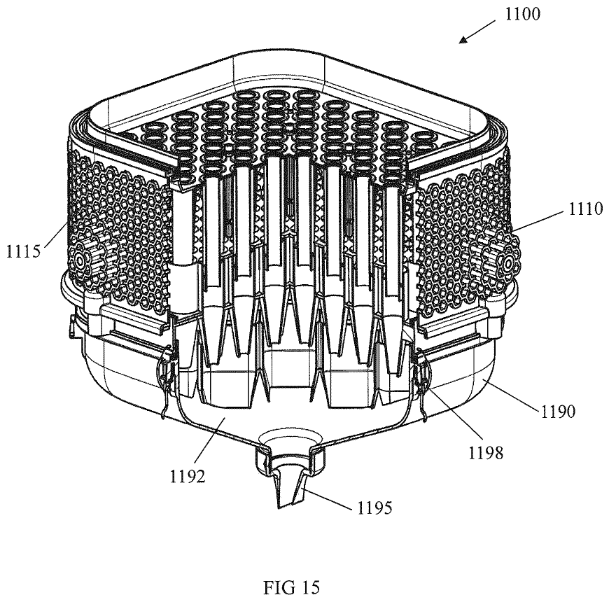

With respect to the cyclone-type pre-cleaner, FIG. 14 is an exploded view which shows one embodiment of a cyclone-type pre-cleaner that may be used in a two-stage air cleaner system of the present disclosure. As shown, the pre-cleaner 1100 includes a pre-cleaner housing 1110; an upper baffle member 1120, a connecting rod 1130 (for securing the upper baffle member), a cyclone tube member set 1140, a lower baffle member 1160, and anti-dust reingestion arrangement 1180 contained in the pre-cleaner housing in that order; and a dust cover 1190 secured to the pre-cleaner housing 1110 by fasteners (e.g., latches). When the above components of the pre-cleaner 1100 are assembled together, they are as shown in FIG. 15.

The pre-cleaner housing 1110 includes an air intake grid or air intake duct 1115, which can be window shaped as shown, providing air intake passage and structural protection for the components contained in the pre-cleaner housing 1110. It should be understood that other forms of air inlets/air passages may also apply to the cyclone-type pre-cleaner of the present disclosure. The pre-cleaner housing 1110 may be integrally injection-molded with the downstream main air cleaner housing or may be connected by welding or fasteners such as bolts.

The dust cover 1190 is secured to one end of the pre-cleaner housing 1110 by a fastener 1198 and forms a dust chamber 1192 in the pre-cleaner housing 1110 to accommodate larger particles of dusts and impurities thrown out by swirling action. Such particles are then discharged from the pre-cleaner 1100 through a dust outlet 1195 at the bottom of the dust chamber 1192. In one embodiment, the dust outlet 1195 includes a dust discharge valve.

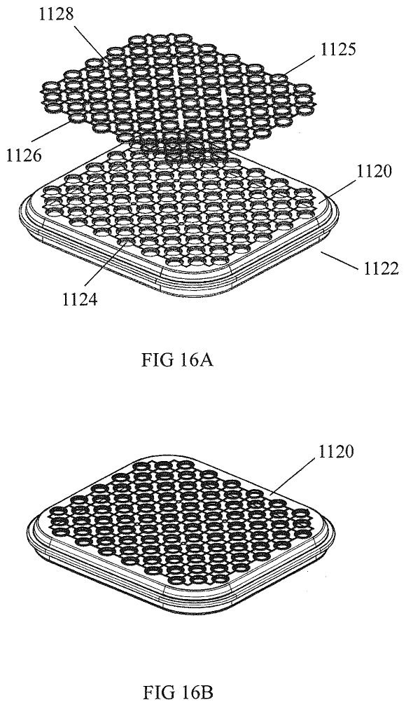

Turning now to FIGS. 16A-16B, which shows an embodiment of an upper baffle member. The upper baffle member 1120 includes an upper baffle plate 1122 and a seal member 1125 attached to the upper baffle plate 1122. The upper baffle plate 1122 includes a plurality of openings/holes 1124. The seal member 1125 is an integrally formed sealing ring gasket. In one embodiment, the seal member 1125 may be a TPE sealing ring gasket integrally formed by overmold injection, which is composed of a plurality of sealing rings 1126 and connecting members 1128 that connect the sealing rings 1126. The location and number of sealing rings 1126 match with the location and number of openings 1124 in the upper baffle plate 1122. When the seal member 1125 is attached to the upper baffle plate 1122, each sealing ring 1126 snaps fit into corresponding opening 1124 in the upper baffle plate 1122, to achieve air-tight engagement.

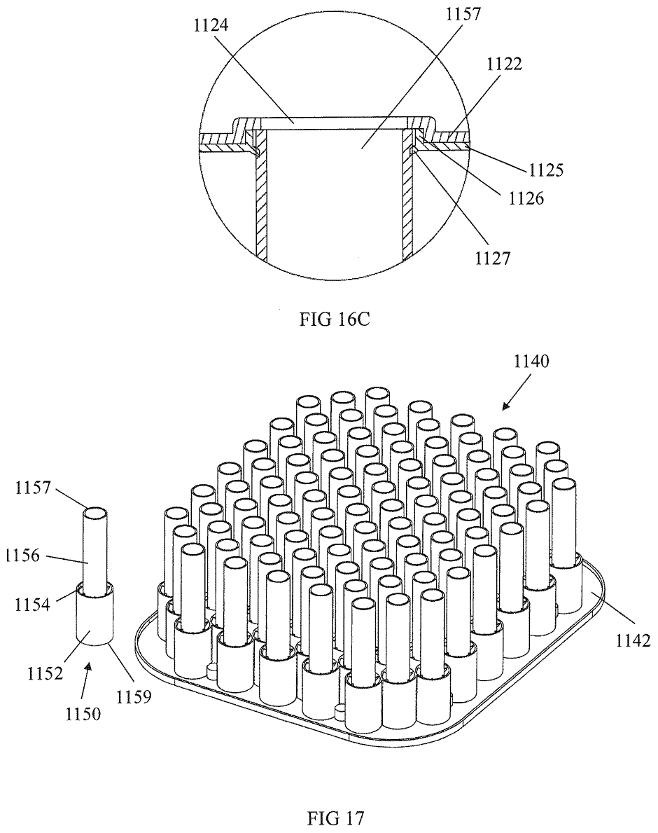

The sealing ring 1126 also has a retainer 1127, as shown in FIG. 16C, to assist the cyclone tube member outlet 1157 (see FIG. 17) in position when connected to the upper baffle plate 1122, and to have the sealing ring 1126 to form a seal with the outlet 1157, so as to effectively prevent air that is not prefiltered from directly flowing to the downstream primary filter cartridge.

An example of a cyclone tube member 1150 is shown in FIG. 17, which comprises an outer straight tube 1152, a vane 1154 in the outer straight tube 1152 and a central tube 1156 extending into the outer straight tube 1152. The outer straight tube 1152, the vane 1154 and the central tube 1156 can be integrally formed together as a single component by an injection molding process. One end of the central tube 1156 is the cyclone tube member outlet 1157, which is secured to corresponding opening 1124 in the upper baffle member 1120 and is fully sealed with corresponding opening 1124 by the sealing ring 1126. See FIG. 16C. One end 1159 of the outer straight tube is secured to the cyclone tube member base plate 1142.

The number of the cyclone tube members 1150 corresponds to the number of openings in the upper baffle member 1120, and the position of each cyclone tube member 1150 matches respective opening in the upper baffle member 1120. During assembly, the central tube 1156 of each cyclone tube member 1150 is right inserted into the matched opening/hole 1124 in the upper baffle member 1120.

The plurality of cyclone tube members 1150 are each secured onto the base plate 1142 to form a set of cyclone tube members, i.e., cyclone tube member set 1140, which can be integrally formed by an injection molding. The integrally formed cyclone tube member set 1140 greatly reduces the number of components, substantially reduces difficulty of assembly, and avoids misalignment of the cyclone tube members. Also, as the central tube 1156, the vane 1154 and the outer straight tube 1152 of individual cyclone tube member 1150 are integrally injection-molded, this avoids interference fit sealing between the central tube 1156, the vane 1154 and the outer straight tube 1152 and one-to-one insertion installation (i.e., the central tube inserts into the outer straight tube and passes through the vane placed in the outer straight tube), which solves the problem of misalignment of the central tube 1156 and the vane 1154 relative to the outer straight tube 1152, and greatly reduces air leakage.

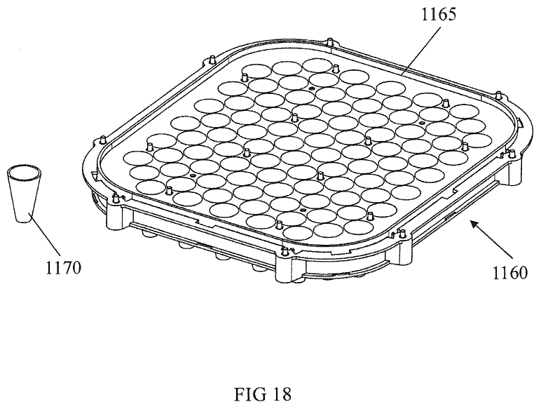

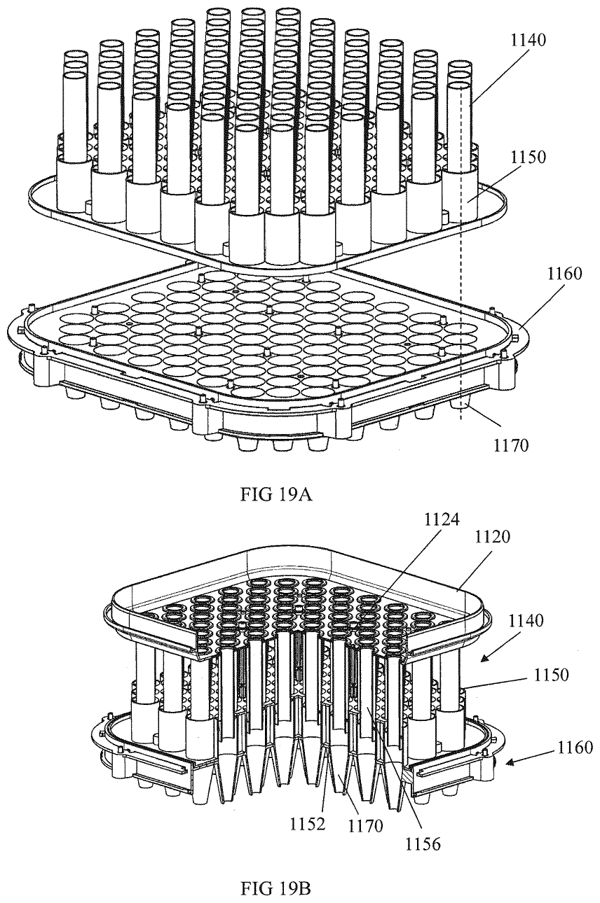

Attention is directed to FIG. 18, which shows a lower baffle member 1160 according to one embodiment of the present disclosure. The lower baffle member 1160 is composed of a lower baffle plate 1165 and a plurality of tapered tubes 1170 secured to the lower baffle plate 1165. In this embodiment, the lower baffle plate 1165 and the plurality of tapered tubes 1170 are integrally formed by injection molding. The number of tapered tubes 1170 matches with the number of cyclone tube members of the cyclone tube member set 1140, with each tapered tube 1170 aligning with corresponding cyclone tube member 1150, as shown in FIG. 19A.

When the upper baffle member 1120, the cyclone tube member set 1140, and the lower baffle member 1160 are assembled together, FIG. 19B, the central tube 1156 of each cyclone tube member 1150 in the cyclone tube member set 1140 is inserted into corresponding opening 1124 with a sealing ring in the upper baffle member 1120, and in seal engagement therewith. The outer straight tube 1152 of each cyclone tube member 1150 in the cyclone tube member set 1140 is aligned with corresponding tapered tube 1170 of the lower baffle member 1160.

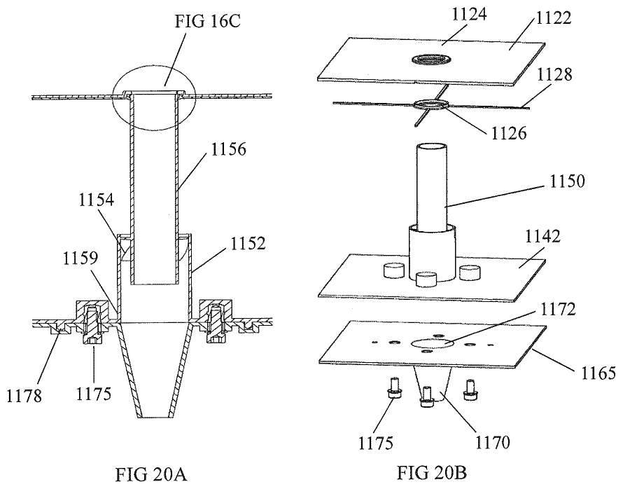

In one embodiment, the cyclone tube member set 1140 and the lower baffle member 1160 can be positioned with pins and sufficiently fastened and sealed with fasteners or adhesives. As an example, FIGS. 20A-20B show alignment and tight seal of a single cyclone tube member 1150 integrally formed onto the cyclone tube member base plate 1142 with a single tapered tube 1170 integrally formed onto the lower baffle plate 1165. It should be understood that the design concept of FIGS. 20A-20B also apply to alignment and seal of each cyclone tube member 1150 of the cyclone tube member set 1140 with respective tapered tube 1170 of the lower baffle member 1160.

In order to have the outer straight tube 1152 of the cyclone tube member 1150 to be aligned with corresponding tapered tube 1170, a pin 1178 is provided on the base plate 1142, and a recess is provided at corresponding position of the lower baffle plate 1165. When the end 1159 of the outer straight tube 1152 is aligned with the end 1172 of the tapered tube 1170, the pin 1178 extends into the recess of the lower baffle plate 1165, and fastener 1175 (e.g., bolts and the like) can be used to seal the base plate 1142 against the lower baffle plate 1165. It should be understood that other positioning means and/or securing designs are also possible.

In this way, the cyclone tube member set 1140 and the lower baffle member 1160 can be tightly sealed together. Also, this ensures alignment of each cyclone tube member 1150 of the cyclone tube member set 1140 with corresponding tapered tube 1170 of the lower baffle member 1160. Even if there may be extremely small amount of air inflow at the interface between the cyclone tube member set 1140 and the lower baffle member 1160, such air will flow and merge into the swirling air in the cyclone tube member 1150 due to the interface is located between the outer straight tube 1152 and the tapered tube 1170 and will not disturb the pre-filtered air flow. Moreover, as the outer straight tube 1152 of each cyclone tube member 1150 of the cyclone tube member set 1140 is aligned with corresponding tapered tube 1170 of the lower baffle member 1160 within allowable error range by means of the positioning design, the airflow passing through the vanes 1154 will not collide on the interface to create turbulence, to avoid the impact on the pre-filtration efficiency.

FIGS. 20A-20B also show a joint seal of the central tube 1156 of a single cyclone tube member 1150 with an opening 1124 on the upper baffle plate having a sealing ring 1126. Details can be found in the description above in connection with FIG. 16C. As such, the upper baffle member 1120 can be assembled with the cyclone tube member set 1140.

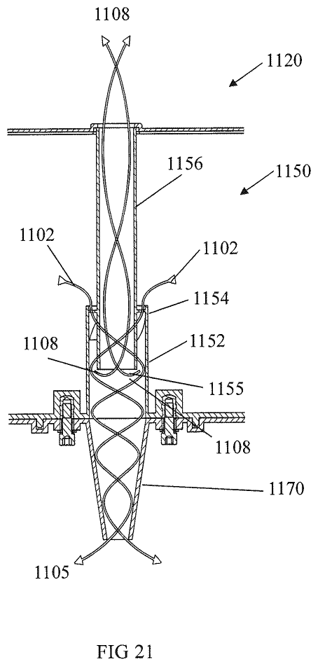

The assembled cyclone tube member 1150 works as follows (see FIG. 21): Dirty air carrying dusts and impurities enters from the intake passages of the pre-cleaner housing and is sucked into the cyclone tube member 1150. Dirty air passes through the vane 1154 as indicated by arrow 1102. Under swirling action, most larger particles of dusts and impurities spin rapidly along the inner wall of the outer straight tube 1152 and move towards the inner wall of the tapered tube 1170, then also spin rapidly along the inner wall of the tapered tube 1170 as shown by arrow 1105 and are thrown out via the outlet of the tapered tube 1170 to the dust chamber, and are discharged from the pre-cleaner through the dust outlet at the bottom of the dust chamber. The air in the central area of the outer straight tube 1152 near the inlet 1155 of the central tube (carrying small amount of smaller particles of dusts and impurities) is turned back 180 degrees, drawn into the central tube 1156 in the direction of arrow 1108 and exits the pre-cleaner. As the cyclone tube member 1150 enables the pre-filtered air to make a 180-degree turn to exit the pre-cleaner, it is also called a cyclone-type pre-cleaner here.

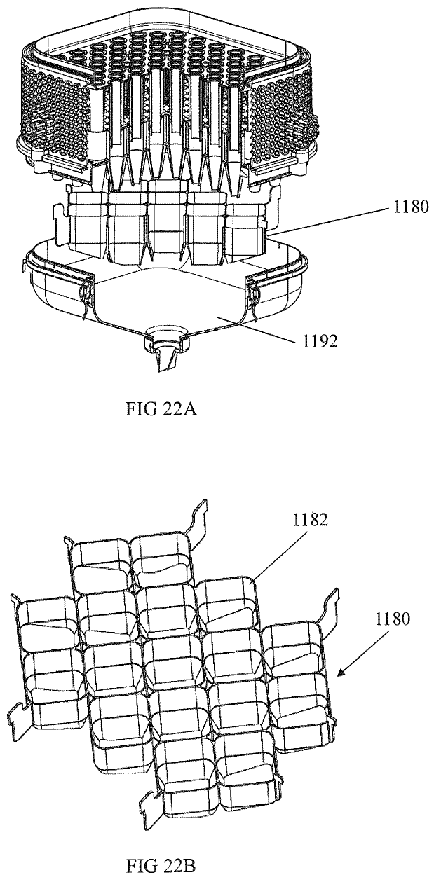

In one embodiment of the present disclosure, an anti-dust reingestion arrangement is arranged in the dust chamber 1192, to alleviate dust reingestion effect when the pre-cleaner system experiences imbalanced air intake. An example of an anti-dust reingestion arrangement 1180 is shown in FIGS. 22A-22B, consisting of a plurality of grids 1182. That is, the grids 1182 divide the dust chamber 1192 into a number of small compartments. Even if the intake air of the pre-cleaner 1100 is imbalanced, intake air in each grid 1182 is relatively balanced. Further, the grids 1182 can effectively block lateral turbulence of airflow that carries dusts in the dust chamber 1192, thereby reducing dust reingestion in the dust chamber 1192, to guarantee more stable performance for the pre-cleaner system.

Experiments show that having anti-dust reingestion arrangement in the dust chamber will not affect initial resistance of the pre-cleaner. In addition, comparing with existing pre-cleaners, the pre-cleaner with anti-dust reingestion structure of the present disclosure allows an increase of pre-filtration efficiency by about 15% under imbalanced air intake.

In one experiment, following ISO-5011 test standards and using ISO 12103-A4 standard coarse dusts, a comparison test is carried out on the cyclone-type pre-cleaner of the present disclosure and a well-designed existing cyclone-type pre-cleaner. The test results show that the pre-filtration efficiency of the cyclone-type pre-cleaner of the present disclosure reaches 97% when the final resistance is 7.5 kPa (i.e., for every 1000 grams of dusts, 970 grams are filtered by the pre-cleaner, and only 30 grams of coarse dusts flow to the primary filter cartridge); while the pre-filtration efficiency of the existing cyclone-type pre-cleaner is 93% when the final resistance is 7.5 kPa (i.e., for every 1000 grams of dusts, 930 grams are filtered by the pre-cleaner, and the remaining 70 grams of coarse dusts flow to the primary filter cartridge). As a comparison, again following ISO-5011 test standards and using ISO 12103-A4 standard coarse dusts, the test results show: for a poorly designed cyclone-type pre-cleaner, the pre-filtration efficiency can only reach 70% when the final resistance is 7.5 kPa (i.e., for every 1000 grams of dusts, 700 grams are filtered by the pre-cleaner, and the remaining 300 grams of coarse dusts flow to the primary filter cartridge); while for a better designed straight-through pre-cleaner, the pre-filtration efficiency can reach 85-89% when the final resistance is 7.5kPa (i.e., for every 1000 grams of dusts, 850-890 grams are filtered by the pre-cleaner, and the remaining 150-110 grams of coarse dusts flow to the primary filter cartridge).

Thus, it can be seen that the cyclone-type pre-cleaner of the present disclosure greatly improves the pre-filtration efficiency (up to more than 97%) over existing cyclone-type pre-cleaner without increasing the initial resistance, which greatly prolongs the service life of the primary filter cartridge and extends maintenance interval of the air cleaner system, and substantially reduces maintenance costs.

It should be understood that the anti-dust reingestion arrangement 1180 may have any structure that divides the dust chamber. Moreover, the anti-dust reingestion arrangement 1180 can be a single piece, as shown in FIG. 22B, placed in the dust chamber 1192. In other embodiments, it can be integrally formed with the lower baffle member (e.g., the lower baffle member 1160), such as, the anti-dust reingestion arrangement 1180 integrated onto the lower baffle member by injection molding. In further embodiments, it can be integrally formed with the dust cover 1192, e.g., the anti-dust reingestion arrangement 1180 integrated onto the dust cover by injection molding.

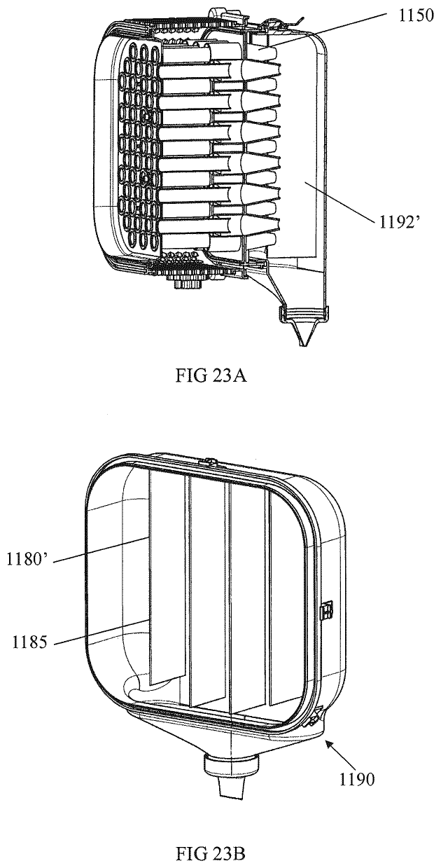

In another embodiment of the present disclosure, an alternative anti-dust reingestion arrangement is provided. Referring to FIGS. 23A-23B, an anti-dust reingestion arrangement 1180′ composed of a plurality of sheet-shaped partitions 1185 is installed in a dust chamber 1192′. The partitions 1185 in this embodiment are vertical partitions, which are especially suitable for horizontally placed cyclone tube members 1150. Similar to the anti-dust reingestion arrangement 1180 discussed above, the anti-dust reingestion arrangement 1180′ also divides the dust chamber 1192′ into a number of small compartments, to maintain relatively balanced air intake in each compartment when the air intake of the pre-cleaner is imbalanced, thereby reducing lateral flow of dusts in the dust chamber 1192′, so as to alleviate dust reingestion effect. Upon experiments, the anti-dust reingestion arrangement 1180′ does not affect the pre-filtration air intake resistance and can improve the pre-filtration performance by more than 15%, and the pre-filtration efficiency can reach up to more than 97%.

It should be understood that the anti-dust reingestion arrangement 1180′ also can have any structure to divide the dust chamber. In addition, the anti-dust reingestion arrangement 1180′ can be a single piece placed in the dust chamber 1192′; or integrally formed with a lower baffle member (e.g., lower baffle member 1160), such as the anti-dust reingestion arrangement 1180′is integrated onto the lower baffle member by injection molding; or, integrally formed with the dust cover (e.g., dust cover 1190), e.g., the anti-dust reingestion arrangement 1180′is integrated onto the dust cover by injection molding.

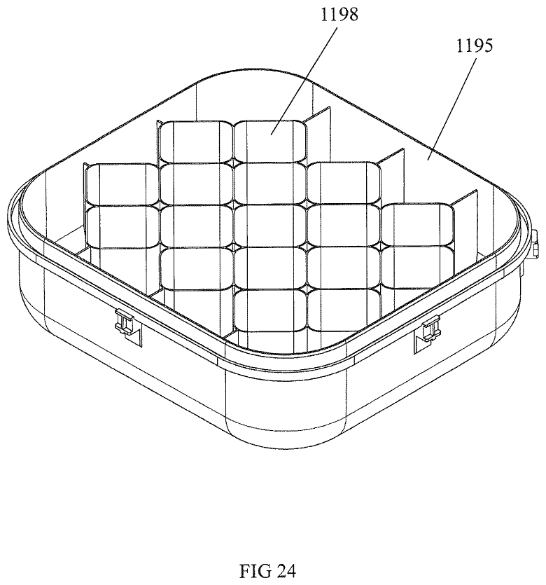

FIG. 24 shows another alternative embodiment. As shown, the flat bottom dust cover 1195 without dust discharge valve is integrated with an anti-dust reingestion grid 1198.

It should be understood that the above embodiments of the cyclone-type pre-cleaner are illustrative only. The structure of the cyclone-type pre-cleaner and its components may vary depending on particular application.

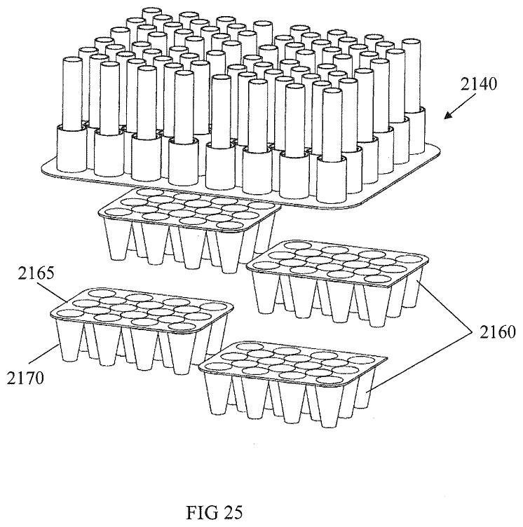

For instance, as shown in FIG. 25, the lower baffle member may include a set of lower baffle members 2160. Each lower baffle member 2160 is composed of a lower baffle plate 2165 and one or more tapered tubes 2170 integrally formed thereon. After the plurality of lower baffle members 2160 are laid out side by side, they can be securely sealed to the cyclone tube member set 2140 by adhesives or fasteners. This embodiment not only further reduces the mold costs of the lower baffle member, but also reduces the accuracy requirements for the component dimensions of the cyclone tube member set and lower baffle member. Further, if certain tapered tube(s) has problem (e.g., a tapered tube being blocked by dusts), only the lower baffle member containing such tapered tube shall be replaced without affecting other lower baffle members. This further reduces costs.

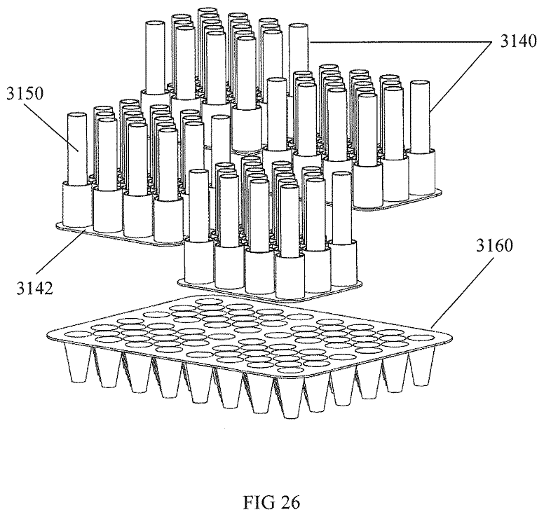

FIG. 26 shows an alternative embodiment of a plurality of cyclone tube member sets 3140 matching with a lower baffle member 3160. In this alternative embodiment, the cyclone tube member set is a collection comprising a plurality of cyclone tube member sets 3140. Each cyclone tube member set 3140 includes a base plate 3142 and one or more cyclone tube members 3150 integrally formed therewith. After the plurality of cyclone tube member sets 3140 are laid out side by side, they can be securely sealed to the lower baffle member 3160 by adhesives or fasteners. This embodiment not only further reduces the mold costs of the cyclone tube member sets, but also reduces the accuracy requirements for component dimensions of the cyclone tube member sets and the lower baffle member. Also, if one cyclone tube member is defective/damaged, only the cyclone tube member set containing such cyclone tube member shall be replaced without affecting other cyclone tube member sets. This further reduces the costs.

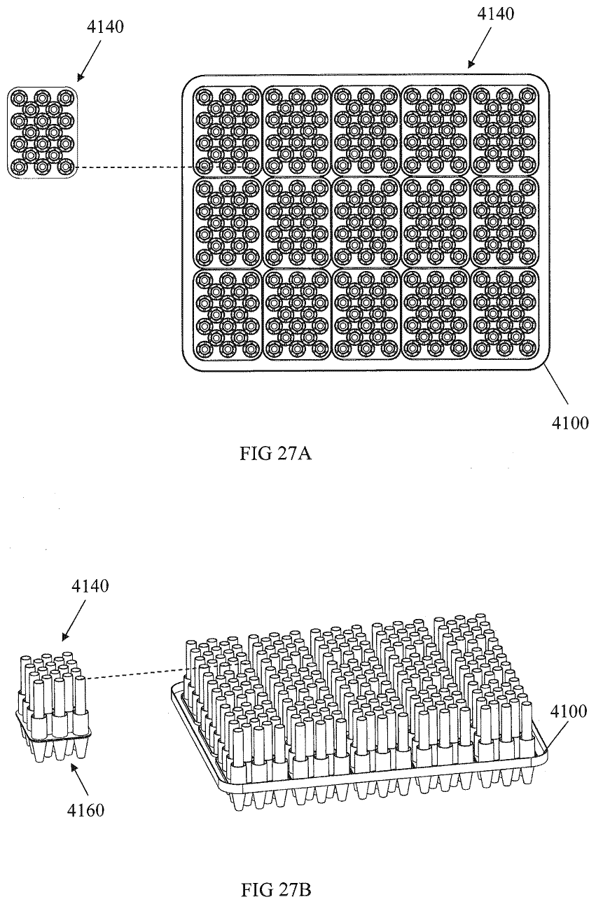

FIGS. 27A-27B illustrate another alternative embodiment. As shown, the cyclone tube member set is a collection that includes a plurality of cyclone tube member sets 4140, and the lower baffle member is a collection that includes a plurality of lower baffle members 4160. A plurality of cyclone tube member sets 4140 and lower baffle members 4160 are secured in pairs and arranged side by side in a base frame 4100. This alternative embodiment allows the cyclone tube structure of the present disclosure to be conveniently and flexibly used in a larger pre-filter module as desired and reduces the accuracy requirements for component dimensions of the cyclone tube member sets 4140 and lower baffle members 4160.

It should be understood that the above cyclone-type pre-cleaners not only can be used in the two-stage air cleaner system of the present disclosure, but they also can be used with any other types of main air cleaners or can be used alone.

The foregoing only shows illustrative embodiments of the disclosure, and does not intend to limit the present disclosure. Any modification, equivalent replacement and/or improvements made within the spirit and principles of the disclosure shall be within the scope of the disclosure. Therefore, the protection scope of the disclosure shall rely on the appended claims.

1. A two-stage air cleaner system with a side-positioned pre-cleaner, comprising:
a main air cleaner and a pre-cleaner arranged at a side of a primary filter cartridge of the main air cleaner, the pre-cleaner having an inlet and an outlet, the outlet facing in a first direction;
wherein the primary filter cartridge includes a dirty side, facing in a second direction orthogonal to the first direction, and an opposite clean side;
wherein air to be filtered, upon being pre-filtered by the pre-cleaner, enters the primary filter cartridge from the dirty side for filtration, and filtered clean air exits from the clean side through an air outlet downstream of the primary filter cartridge;
wherein, when the two-stage air cleaner system is in use, some of the dust and impurities collected in upstream channels inside the primary filter cartridge can fall into a dust removal arrangement arranged beneath the primary filter cartridge under gravity, to automatically discharge from the main air cleaner.

2. The two-stage air cleaner system according to claim 1, wherein a safety cartridge is arranged downstream of the primary filter cartridge; and clean air of the primary filter cartridge enters the safety cartridge from the clean side for secondary filtration, and then exits through an air outlet downstream of the safety cartridge.

3. The two-stage air cleaner system according to claim 1, wherein the primary filter cartridge is a straight-flow filter cartridge.

4. The two-stage air cleaner system according to claim 3, wherein the primary filter cartridge includes a media pack comprising media of a fluted sheet secured to a face sheet, having a first edge and an opposite second edge, wherein the first edge forms the dirty side of the primary filter cartridge, and the second edge forms the clean side of the primary filter cartridge; wherein sealant beads are provided near the second edge to seal the fluted sheet and the face sheet together and to prevent the air to be filtered from flowing out of the clean side without being filtered by the media pack; and wherein the air to be filtered enters open flutes at the dirty side, passes through the media pack into adjacent channels, and exits from the clean side.

5. The two-stage air cleaner system according to claim 4, wherein the open flutes at the dirty side form open channels inside the primary filter cartridge to adsorb dust and impurities.

6. The two-stage air cleaner system according to claim 5, wherein the dust removal arrangement is funnel shaped for accumulating dust and impurities, and the dust removal arrangement includes a dust discharge valve.

7. The two-stage air cleaner system according to claim 6, wherein the two-stage air cleaner system, when in operation, vibrates to cause dust and impurities to fall into the dust removal arrangement under gravity and accumulate above the dust discharge valve until a weight of the accumulated dust and impurities above the discharge valve is sufficient to overcome negative pressure inside the main air cleaner, at which time, the accumulated dust and impurities discharge from the main air cleaner through the dust discharge valve.

8. The two-stage air cleaner system according to claim 7, wherein the media pack of the primary filter cartridge is one of a coiled media pack, a stacked media pack, and a deep pleated panel-type filter cartridge.

9. (canceled)

10. (canceled)

11. The two-stage air cleaner system according to claim 1, wherein the pre-cleaner includes an air inlet, a bank of cyclone tubes installed in the pre-cleaner, a dust chamber downstream of the bank of cyclone tubes, and a dust outlet under the dust chamber; wherein, as dirty air enters the pre-cleaner from the air inlet, under swirling action of the bank of cyclone tubes, particles of dust and impurities are thrown into the dust chamber and discharged from the dust outlet, and the pre-filtered air then flows to the dirty side of the primary filter cartridge.

12. A two-stage air cleaner system with a side-positioned pre-cleaner, comprising:
a main air cleaner including a primary filter cartridge defining an outer perimeter extending between an inlet side and an outlet side; and
a pre-cleaner, including a plurality of separator tubes, arranged at a side of the primary filter cartridge such that an outlet of the pre-cleaner faces the primary filter cartridge outer perimeter,
wherein air to be filtered, upon being pre-filtered by the pre-cleaner, changes direction and enters the primary filter cartridge from the inlet side for filtration by the primary filter cartridge, and the filtered clean air is discharged from the outlet side.

13. A pre-cleaner, comprising:
a pre-cleaner housing for providing air intake passage;
an upper baffle member, a cyclone tube member set, and a lower baffle member contained in the pre-cleaner housing; and
a dust cover connected to the pre-cleaner housing to form a dust chamber within the pre-cleaner housing;
wherein, the upper baffle member has a plurality of openings;
wherein, the cyclone tube member set includes a base plate and a plurality of cyclone tube members secured to the base plate, each cyclone tube member composed of an outer straight tube, a vane in the outer straight tube, and a central tube inserted into the outer straight tube, the outer straight tube, vane, and central tube being integrally formed as a single component;
wherein, the number and position of the cyclone tube members match with the number and position of the openings of the upper baffle member, and an end of the central tube of each cyclone tube member extends into a corresponding opening of the upper baffle member; and
wherein, the lower baffle member has a plurality of tapered tubes, the number of which corresponds to the number of the cyclone tube members, and an end of the outer straight tube of each cyclone tube member aligns with an end of a corresponding tapered tube.

14. The pre-cleaner according to claim 13, wherein the upper baffle member includes an upper baffle plate and a seal member attached to the upper baffle plate; wherein, the upper baffle plate includes a plurality of openings; wherein the seal member is an integrally formed sealing ring gasket including a plurality of sealing rings, the position and number of the sealing rings matching with the position and number of the openings in the upper baffle plate; and wherein each sealing ring forms an airtight seal with a respective opening in the upper baffle plate.

15. The pre-cleaner according to claim 14, wherein the seal member is an integrally formed TPE sealing ring gasket, engaged to the upper baffle plate.

16. The pre-cleaner according to claim 14, wherein each sealing ring has a retainer for assisting an end of the central tube of each cyclone tube member that extends into a respective opening in position, wherein the sealing ring forms a seal with the end of the central tube so as to prevent un-prefiltered air from flowing out of the pre-cleaner.

17. The pre-cleaner according to claim 13, wherein the base plate and the plurality of cyclone tube members secured to the base plate are integrally formed.

18. The pre-cleaner according to claim 13, wherein the lower baffle member includes a lower baffle plate and a plurality of tapered tubes secured to the lower baffle plate that are integrally formed.

19. The pre-cleaner according to claim 13, wherein the cyclone tube member set is positioned relative to the lower baffle member with guide pins and sealingly engaged thereto by way of adhesives or fasteners.

20. The pre-cleaner according to claim 13, wherein the dust chamber is provided with an anti-dust reingestion arrangement.

21-30. (canceled)

31. The two-stage air cleaner system of claim 12, wherein the inlet side of the primary filter cartridge faces in a direction that is orthogonal to the outlet of the pre-cleaner.

32. The two-stage air cleaner system of claim 12, further comprising:
a housing assembly within which at least the primary filter cartridge is installed, the housing assembly defining a dust collection area located directly below the inlet side of the primary filter cartridge and including a dust discharge valve arranged to remove dust from the dust collection area.
